(19) United States
(12) Patent Application Publication
(10) Pub. No.: US 2022/0145161 A1
(43) Pub. Date: May 12, 2022

(54) GREEN COMPOSITIONS FOR USE IN DOWNHOLE AND INDUSTRIAL APPLICATIONS

(71) Applicant: Delta-Energy Group, LLC, Natchez, MS (US)

(72) Inventor: Lloyd Lane, Natchez, MS (US)

(73) Assignee: Delta-Energy Group, LLC, Natchez, MS (US)

(21) Appl. No.: 17/223,930

(22) Filed: Apr. 6, 2021

Related U.S. Application Data
(60) Provisional application No. 63/122,770, filed on Dec. 8, 2020.
(60) Provisional application No. 63/111,399, filed on Nov. 9, 2020.

(51) Int. Cl. C09K 8/524; C09K 8/54

(52) U.S. Cl. CPC C09K 8/524; C09K 2208/32; C09K 8/54

(57) ABSTRACT

Crude oil may be treated with an additive made with Tire Pyrolysis Oil and naphtha, condensate, or both naphtha and condensate. Also disclosed herein are compositions including Tire Pyrolysis Oil wherein the composition is selected from the group consisting of: pipeline cleaner, tank cleaner, paraffin inhibitor or modifier, asphaltene inhibitor or modifier, scale inhibitor, corrosion inhibitor, stimulation fluid, crude oil density reducer, and crude oil viscosity reducer. The Tire Pyrolysis Oil is a green product recovered from recycling tires.

### CROSS REFERENCE TO RELATED APPLICATIONS

This patent application claims the benefit of U.S. Provisional Application No. 63/122,770 filed Dec. 8, 2020 and 63/111,399 filed Nov. 9, 2020. Both of these applications are incorporated by reference herein in their entirety.

### TECHNICAL FIELD

The present invention relates to products prepared employing hydrocarbon compositions. The present invention particularly relates to products prepared employing hydrocarbons recovered from recycling tires.

### BACKGROUND

The global economy generates approximately 2 billion end-of-life tires annually. Often these tires are sent to landfills, incinerators, or abandoned at illegal dump sites where they create pollution and vectors for disease.

End-of-life tires are valuable chemical resources. Tire pyrolysis can produce recovered carbon black to make new tires or rubber products as well as valuable liquid co-products for specialty chemical and fuel uses. Processing end-of-life tires in this way is an important aspect of the circular economy that advances the principles of reduce, reuse, and recycle.

Recycling end-of-life also tires has a much smaller environmental footprint than producing these materials in conventional ways. Greenhouse gas emissions associated with the production of recovered carbon black are substantially lower than virgin carbon black. For this reason, materials produced from tire pyrolysis commonly are referred to as “green” products.

It would be desirable in the art of preparing hydrocarbon-based compositions for commercial use to employ hydrocarbons which are recovered from tire pyrolysis.

### SUMMARY

In one aspect, the invention is a composition comprising tire pyrolysis oil wherein the composition is selected from the group consisting of: pipeline cleaner, tank cleaner, paraffin inhibitor, paraffin modifier, asphaltene inhibitor, asphaltene modifier, scale inhibitor, corrosion inhibitor, stimulation fluid, crude oil density reducer, and crude oil viscosity reducer.

In another aspect, the invention is a crude oil additive comprising naphtha and Tire Pyrolysis Oil.

In still another aspect, the invention is a crude oil additive comprising condensate and Tire Pyrolysis Oil

Finally, an aspect of the invention is a method for reducing the viscosity of heavy or heavy crude oil comprising introducing a viscosity reducing agent into the crude oil wherein the viscosity reducing agent comprises a diluent and Tire Pyrolysis Oil.

### BRIEF DESCRIPTION OF THE DRAWING

The patent or application file contains at least one drawing executed in color. Copies of this patent or patent application publication with color drawing(s) will be provided by the Office upon request and payment of the necessary fee.

For a detailed understanding of the present disclosure, references should be made to the following detailed description of the preferred embodiment, taken in conjunction with the accompanying drawings listed below:

FIG. 1 is a graph showing the relationship between substituting small amounts of Tire Pyrolysis Oil for condensate used as diluent for Heavy Crude Oil and the resulting normalized viscosity of the Heavy Crude Oil.

FIG. 2 is a graph illustrating the improvement observed with using 1 volume percent Tire Pyrolysis Oil on viscosity.

FIG. 3 is a graph illustrating the improvement observed with using 0.5 volume percent Tire Pyrolysis Oil on density.

FIG. 4 is a graph illustrating the improvement observed in using Tire Pyrolysis Oil and naphtha to reduce the crude oil density.

### DETAILED DESCRIPTION

In one aspect, the invention of the application is a composition comprising the hydrocarbons derived from pyrolysis of tires (Tire Pyrolysis Oil) wherein the composition is selected from the group consisting of: pipeline cleaner, tank cleaner, paraffin inhibitor or modifier, asphaltene inhibitor or modifier, scale inhibitor, corrosion inhibitor, stimulation fluid, crude oil density reducer and crude oil viscosity reducer.

In the practice of the present application, Tire Pyrolysis Oil is employed in replacing other hydrocarbons in preparing commercial functional agents in diverse applications. Tire Pyrolysis Oil is prepared by subjecting rubber and carbon black based tires to a process that includes depolymerizing the rubber to produce a hydrocarbon stream. Optionally, the process may include steps such as removing metal from the tires prior to processing and recovering other products such as fillers like carbon particles.

The Tire Pyrolysis Oil may be prepared by any process known to be useful to those of ordinary skill in the art. The Tire Pyrolysis Oil may be prepared employing a low energy method of pyrolysis of rubber, especially rubber recovered during tire recycling. In this process the rubber is heated in the presence of a clay or clay and elemental metal catalysts. High quality carbon black and Tire Pyrolysis Oil are produced with a substantial reduction in the amount of energy expended and carbon dioxide produced. This method is disclosed, in part, in U.S. Pat. No. 6,835,861 which is incorporated herein by reference in its entirety.

In the '861 process, a low energy method of pyrolysis of rubber is provided wherein the rubber is heated while maintaining a vacuum, using a clay catalyst. In an additional embodiment, this reference discloses that the temperature of the reaction chamber and corresponding fuel input is varied either over time or spatially within the reaction chamber.

Another process for preparing the tire pyrolysis can be found in United States Patent Publication No. 2008/0096787 which is incorporated herein by reference in its entirety.

In this process, a method of manufacturing a solvent from rubber tires is disclosed that involves conveying tire particles into a rotary drum heated to 730-800° F. under vacuum to generate hydrocarbon vapors and carbon black solids. The vapors pass through a condensing column to collect liquid hydrocarbons. The resulting solvent contains a high percentage by volume of both Limonene and naphthalene.

Generally, Tire Pyrolysis Oil is a very complex mixture of hydrocarbons including alkanes, alkenes, amines, amides, esters, and thio-compounds. For example, in one embodiment, the Tire Pyrolysis Oil can have a composition of:

| | | | | | | | | |
|---|---|---|---|---|---|---|---|---|
| | | | Time | DL | Area | RF | RF | Result |
| Compound | MW | CAS No. | min. | % | (for calc'n) | Factor | adjustment | Percent |

| | | | | | | | |
|---|---|---|---|---|---|---|---|
| Hydrogen Sulfide | 34.2 | 7783-06-4 | 1.1 | 88982 | 1.0 | 0.0 | 0.0073 |
| Propylene | 42.1 | 115-07-1 | 1.1 | 86982 | 1.0 | 0.0 | 0.0073 |
| Propane | 44.1 | 74-98-6 | 1.1 | 86982 | 1.0 | 0.0 | 0.0073 |
| Isobutylene | 56.1 | 115-11-7 | 1.2 | 440206 | 1.0 | 0.0 | 0.037 |
| Butane | 58.1 | 105-97-8 | 1.2 | 146735 | 1.0 | 0.0 | 0.012 |
| Methyl Mercaptan | 48.2 | 74-93-1 | 1.2 | 71053 | 1.0 | 0.0 | 0.0060 |
| 3-Methyl-1-butene | 70.1 | 563-45-1 | 1.2 | 212951 | 1.0 | 0.0 | 0.018 |
| Isopentane | 72.1 | 78-78-4 | 1.2 | 141102 | 1.0 | 0.0 | 0.012 |
| 2-Methyl-1-butene | 70.1 | 563-46-2 | 1.3 | 1591666 | 1.0 | 0.1 | 0.13 |
| Isoprene | 68.1 | 78-70-5 | 1.3 | 3923031 | 1.0 | 0.3 | 0.33 |
| t-2-Pentene | 70.1 | 627-20-3 | 1.3 | 4986014 | 1.0 | 0.4 | 0.42 |
| Cyclopentadiene | 66.1 | 542-92-7 | 1.3 | 605005 | 1.0 | 0.1 | 0.051 |
| C [symbol] H [symbol] | 68.1 | 18631-83-9 | 1.4 | 883300 | 1.0 | 0.1 | 0.074 |
| C₆H₁₂ | 84.1 | 558-37-2 | 1.4 | 924623 | 1.0 | 0.1 | 0.078 |
| 3-Methylpentane | 86.1 | 96-14-0 | 1.5 | 170255 | 1.0 | 0.0 | 0.014 |
| 1-Hexene | 84.1 | 592-41-6 | 1.5 | 1183289 | 1.0 | 0.1 | 0.100 |
| C₆H₁₂ | 84.1 | 760-21-4 | 1.5 | 462038 | 1.0 | 0.0 | 0.041 |
| t-4-Methyl-2-pentane | 84.1 | 674-76-0 | 1.5 | 1391934 | 1.0 | 0.1 | 0.12 |
| t-2-Methyl-2-pentane | 84.1 | 616-12-6 | 1.6 | 959577 | 1.0 | 0.1 | 0.081 |
| 23-Methylcyclopentene | 82.1 | 1120-62-3 | 1.6 | 693884 | 1.0 | 0.1 | 0.058 |
| [symbol] -3-Methyl-2-pentene | 84.1 | 922-62-3 | 1.6 | 1714300 | 1.0 | 0.1 | 0.14 |
| Methylcyclopentane | 84.1 | 96-37-7 | 1.7 | 597749 | 1.0 | 0.1 | 0.050 |
| t-2-Methyl-1,3-pentadiene | 82.1 | 926-54-4 | 1.7 | 1116489 | 1.0 | 0.1 | 0.094 |
| c [symbol] H [symbol] | 80.1 | 592-57-4 | 1.7 | 2921230 | 1.0 | 0.2 | 0.25 |
| 1,3-Cyclohexadiene | 80.1 | 592-48-3 | 1.7 | 1891691 | 1.0 | 0.2 | 0.16 |
| C [symbol] H [symbol] | 82.1 | 509-48-3 | 1.8 | 4580455 | 1.0 | 0.4 | 0.39 |
| Benzene | 78.1 | 71-43-2 | 1.8 | 5134688 | 1.0 | 0.4 | 0.43 |
| 1,4-Cyclohexadiene | 80.1 | 828-11-1 | 1.9 | 657582 | 1.0 | 0.1 | 0.055 |
| 3-Methylhexane | 100.1 | 589-34-1 | 1.9 | 518793 | 1.0 | 0.0 | 0.044 |
| Cyclohexane | 82.1 | 110-83-8 | 2.0 | 441349 | 1.0 | 0.0 | 0.037 |
| t-1-2-Dimethylcyclopentane | 98.1 | 822-50-4 | 2.0 | 326519 | 1.0 | 0.0 | 0.028 |
| 1-Heptene | 98.1 | 592-76-7 | 2.0 | 2490947 | 1.0 | 0.2 | 0.21 |
| Heptane | 100.1 | 142-82-5 | 2.1 | 1104361 | 1.0 | 0.1 | 0.093 |
| C₇H₁₂ | 96.1 | 999-78-0 | 2.1 | 3088388 | 1.0 | 0.3 | 0.26 |
| [symbol] -3-Methyl-2-hexene | 98.1 | 10574-36-1 | 2.2 | 826240 | 1.0 | 0.1 | 0.070 |
| 1,5-Dimethylcyclopentene | 96.1 | 16491-13-9 | 2.3 | 1649252 | 1.0 | 0.1 | 0.14 |
| C₇H₁₄ | 98.1 | 10574-37-5 | 2.4 | 1348723 | 1.0 | 0.1 | 0.11 |
| 5,5-Dimethyl-1,3-cyclopentadiene | 94.1 | 4125-18-2 | 2.4 | 541240 | 1.0 | 0.0 | 0.046 |
| Methylcyclohexene | 96.1 | 591-19-1 | 2.5 | 261266 | 1.0 | 0.0 | 0.022 |
| Ethylcyclopentane | 98.1 | 1640-89-7 | 2.5 | 347491 | 1.0 | 0.0 | 0.029 |
| Methyl Isobutyl Ketone (MIBK) | 100.1 | 108-10-1 | 2.6 | 1350223 | 1.0 | 0.1 | 0.11 |
| Methyl-t-1,3,5-hexudene | 94.1 | 24587-26-6 | 2.6 | 7613328 | 1.0 | 0.6 | 0.64 |
| C₇H [symbol] | 94.1 | 4313-57-9 | 2.6 | 959917 | 1.0 | 0.1 | 0.081 |
| 1,3-Dimethylcyclopentadiene | 94.1 | 4784-86-5 | 2.7 | 2400212 | 1.0 | 0.2 | 0.20 |
| 1,5-Dimethylcyclopentene | 96.1 | 16491-15-9 | 2.7 | 6149101 | 1.0 | 0.5 | 0.52 |
| 3-Ethylcyclopentene | 96.1 | 694-35-9 | 2.8 | 898448 | 1.0 | 0.1 | 0.076 |
| Methyl-t-1,3,5-hexadiene | 94.1 | 19264-50-7 | 2.8 | 1317231 | 1.0 | 0.1 | 0.11 |
| 2-Methylheptane | 114.1 | 592-27-8 | 2.9 | 2133880 | 1.0 | 0.2 | 0.18 |
| Toluene | 92.1 | 108-88-3 | 3.0 | 31565544 | 1.0 | 2.7 | 2.7 |
| Methylcyclohexene | 96.1 | 591-49-1 | 3.0 | 4905581 | 1.0 | 0.4 | 0.41 |
| 1,3-Cycloheptadiene | 98.1 | 4054-38-0 | 3.1 | 604881 | 1.0 | 0.1 | 0.051 |
| 4-Methyl-1,4-Hexadiene | 96.1 | 1116-90-1 | 3.2 | 2220078 | 1.0 | 0.2 | 0.19 |
| C [symbol] H [symbol] | 112.1 | 2202-04-7 | 3.2 | 2620585 | 1.0 | 0.2 | 0.22 |
| C₇H₁₂O | 112.1 | 4541-32-6 | 3.3 | 1367783 | 1.0 | 0.1 | 0.12 |
| 1-Octene | 112.1 | 111-66- [symbol] | 3.4 | 3420697 | 1.0 | 0.3 | 0.29 |
| Octane | 114.1 | 111-65-9 | 3.6 | 931697 | 1.0 | 0.1 | 0.079 |
| Vinylcyclohexane | 110.1 | 695-12-5 | 3.6 | 2005106 | 1.0 | 0.2 | 0.17 |
| C₈H₁₂ | 108.1 | [symbol] -84-9 | 3.7 | 414784 | 1.0 | 0.0 | 0.35 |
| C₈H₁₆ | 112.1 | 2207-03-6 | 3.8 | 1994483 | 1.0 | 0.2 | 0.17 |
| 4-Ethylcyclohexene | 110.1 | 3742-42-5 | 3.8 | 242192 | 1.0 | 0.0 | 0.020 |
| C₈H₁₂ | 108.1 | 4430-91-5 | 3.8 | 149091 | 1.0 | 0.0 | 0.013 |
| [symbol] -2-Octene | 112.1 | 7642-04- [symbol] | 3.9 | 582480 | 1.0 | 0.0 | 0.049 |
| C [symbol] H₁₄ | 110.1 | 29253-64-3 | 3.9 | 11402 [symbol] 0 | 1.0 | 0.1 | 0.096 |
| Isopropylcyclopentene | 110.1 | 1462-07-3 | 4.0 | 1093845 | 1.0 | 0.1 | 0.092 |
| C [symbol] H₁₄ | 110.1 | 1090142-17- [symbol] | 4.2 | 4713835 | 1.0 | 0.4 | 0.40 |
| Dimethylcyclohexane | 110.1 | [symbol] | 4.2 | 2534939 | 1.0 | 0.2 | 0.21 |
| Dimethylcyclohexene | 110.1 | [symbol] | 4.3 | 799208 | 1.0 | 0.1 | 0.067 |
| C₉H₁₄ | 122.1 | [symbol] | 4.5 | 2371811 | 1.0 | 0.2 | 0.20 |
| Trimethylcyclohexane | 126.1 | 3073-66- [symbol] | 4.6 | 719689 | 1.0 | 0.1 | 0.061 |
| C₈H₁₂ | 108.1 | 4430-91- [symbol] | 4.7 | 914620 | 1.0 | 0.1 | 0.077 |
| C₉H₁₄ | 122.1 | 4249-12-1 | 4.7 | 1350085 | 1.0 | 0.1 | 0.11 |
| C₈H₁₂ | 108.1 | 83615-96-7 | 4.8 | 2151387 | 1.0 | 0.2 | 0.18 |
| Tetrahydromethylthiophene | 102.2 | 1795-09-1 | 4.9 | 2072877 | 1.0 | 0.2 | 0.17 |
| C [symbol] H [symbol] | 124.1 | 370 [symbol] -05-8 | 5.1 | 470784 | 1.0 | 0.0 | 0.040 |
| C₈H₁₂ | 108.1 | 818-48-4 | 5.2 | 1453980 | 1.0 | 0.1 | 0.12 |
| C₉H [symbol] | 124.1 | 41142-34-5 | 5.3 | 1572120 | 1.0 | 0.1 | 0.13 |
| Ethylbenzene | 106.1 | [symbol] | 5.3 | 12448826 | 1.0 | 1.0 | 1.0 |
| C₈H₁₂ | 108.1 | [symbol] | 5.4 | 2350462 | 1.0 | 0.2 | 0.20 |
| C [symbol] H [symbol] | 124.1 | 201 [symbol] 4-89- [symbol] | 5.5 | 1223017 | 1.0 | 0.1 | 0.10 |
| m-Xylene | 106.1 | 108-38- [symbol] | 5.6 | 45286796 | 1.0 | 3.6 | 3.8 |
| p-Xylene | 106.1 | 106-42- [symbol] | 5.7 | 6626683 | 1.0 | 0.6 | 0.58 |
| C [symbol] H [symbol] | 108.1 | 1000150-54-4 | 5.8 | 1399013 | 1.0 | 0.1 | 0.12 |
| Dimethylthiophene | 112.2 | 638- [symbol] 0-6 | 5.9 | 1170508 | 1.0 | 0.1 | 0.099 |
| C₈H₁₂O | 124.1 | 1767-84-6 | 6.1 | 2 [symbol] 1 [symbol] | 1.0 | 0.2 | 0.21 |
| Dimethylthiophene | 112.2 | 632-16- [symbol] | 6.1 | 3641747 | 1.0 | 0.3 | 0.31 |
| Styrene | 104.1 | 100-42-5 | 6.3 | 82 [symbol] 5 | 1.0 | 0.7 | 0.70 |
| [symbol] -Xylene | 106.1 | 93-47-6 | 6.3 | 12610794 | 1.0 | 1.1 | 1.1 |
| C [symbol] H [symbol] | 126.1 | 6434-78-2 | 6.4 | 741452 | 1.0 | 0.1 | 0.063 |
| C [symbol] H [symbol] O | 122.1 | 2220-40-8 | 6.6 | 379997 | 1.0 | 0.0 | 0.032 |
| C [symbol] H [symbol] | 108.1 | 72347-62- [symbol] | 6.6 | 3840374 | 1.0 | 0.3 | 0.32 |
| C [symbol] H [symbol] | 122.1 | 1000196-61-0 | 6.7 | 1678943 | 1.0 | 0.1 | 0.14 |
| C [symbol] H [symbol] | 122.1 | 1000162-2 [symbol] -6 | 6.8 | 1 [symbol] 4 | 1.0 | 0.2 | 0.15 |
| Pentamethylcyclopentadiene | 136.1 | 4045-44-7 | 7.0 | 1943456 | 1.0 | 0.2 | 0.16 |
| C [symbol] H₁₆ | 124.1 | 4631-87-1 | 7.1 | 841019 | 1.0 | 0.1 | 0.071 |
| Isopropylbenzene (Camen [symbol] ) | 120.1 | 98-82- [symbol] | 7.2 | 3663418 | 1.0 | 0.2 | 0.22 |
| C [symbol] H [symbol] | 138.1 | 3982-03-7 | 7.3 | [symbol] 4836 | 1.0 | 0.1 | 0.058 |
| C [symbol] H [symbol] | 136.1 | 10001 [symbol] 3- [symbol] 7-0 | 7.4 | 2275534 | 1.0 | 0.2 | 0.19 |
| Propylcyclohexene | 124.1 | 253 [symbol] -75-5 | 7.4 | 1143853 | 1.0 | 0.1 | 0.096 |
| C [symbol] H [symbol] | 136.1 | 99-85-4 | 7.5 | 794493 | 1.0 | 0.1 | 0.087 |
| C [symbol] H [symbol] | 138.1 | 7712-74-3 | 7.6 | 1658437 | 1.0 | 0.1 | 0.14 |
| C [symbol] H [symbol] O | 124.1 | 10001 [symbol] -1 [symbol] -0 | 7.7 | 2022171 | 1.0 | 0.2 | 0.17 |
| C [symbol] H [symbol] | 138.1 | 5256-65-5 | 7.7 | 1012814 | 1.0 | 0.1 | 0.085 |
| C [symbol] H [symbol] | 136.1 | 42123-66-0 | 7.8 | 6196784 | 1.0 | 0.5 | 0.52 |
| 2-Propenylbenzene | 118.1 | 300-57-2 | 7.9 | 10817933 | 1.0 | 0.1 | 0.091 |
| C [symbol] H [symbol] O | 138.1 | 100141-30-7 | 7.9 | 1341402 | 1.0 | 0.1 | 0.11 |
| C [symbol] H [symbol] | 138.1 | 20536-41-8 | 8.0 | 1162226 | 1.0 | 0.1 | 0.097 |
| C [symbol] H [symbol] | 136.1 | 61141-57-9 | 8.0 | 1722628 | 1.0 | 0.1 | 0.15 |
| Propylbenzene | 120.1 | 103-65-1 | 8.1 | 3484732 | 1.0 | 0.3 | 0.29 |
| 1-Decene | 140.1 | 872-05-9 | 8.1 | 4324516 | 1.0 | 0.4 | 0.36 |
| C [symbol] H [symbol] | 136.1 | 5989-54-8 | 8.2 | 10540182 | 1.0 | 0.9 | 0.89 |
| Ethyltoluene isomer | 120.1 | 622-96-8 | 8.3 | 18578550 | 1.0 | 1.6 | 1.6 |
| Ethyltoluene isomer | 120.1 | 620-14-4 | 8.4 | 20340905 | 1.0 | 1.7 | 1.7 |
| 1,3,5-Trimethylbenzene | 120.1 | 108-67-8 | 8.5 | 9969255 | 1.0 | 0. | 0.84 |
| C [symbol] H [symbol] | 136.1 | 74653-83-5 | 8.6 | 3423583 | 1.0 | 0.3 | 0.29 |
| [symbol] | 93.1 | 62- [symbol] -3 | 8.7 | 2877948 | 1.0 | 0.2 | 0.24 |
| Ethyltoluene isomer | 120.1 | 611-14-3 | 8.7 | 9927497 | 1.0 | 0.6 | 0.84 |
| alpha-Methyl [symbol] | 118.1 | 98-83- [symbol] | 8.8 | 5984281 | 1.0 | 0.5 | 0.50 |
| C [symbol] H [symbol] | 136.1 | 7216-56-0 | 8.8 | 5984281 | 1.0 | 0.6 | 0.50 |
| C [symbol] H [symbol] | 138.1 | 33501-88-1 | 8.9 | 8047381 | 1.0 | 0.7 | 0.68 |
| C [symbol] H [symbol] | 138.1 | 31222-43-2 | 9.0 | 8287080 | 1.0 | 0.7 | 0.7 |
| 1,2,4-Trimethylbenzene | 120.1 | 95-63-6 | 9.1 | 28736730 | 1.0 | 2.4 | 2.4 |
| C [symbol] H [symbol] | 138.1 | 74620-29-8 | 9.2 | 15434831 | 1.0 | 1.3 | 1.3 |
| C [symbol] H [symbol] | 136.1 | 18172-67-3 | 9.4 | 3276299 | 1.0 | 0.3 | 0.28 |
| C [symbol] H [symbol] | 122.1 | 37439-53-5 | 9.4 | 8938314 | 1.0 | 0.6 | 0.58 |
| C [symbol] H [symbol] | 138.1 | 61228-10-2 | 9.5 | 4230571 | 1.0 | 0.4 | 0.36 |
| C [symbol] H [symbol] | 136.1 | 33622-26-3 | 9.6 | 5974844 | 1.0 | 0.5 | 0.50 |
| 2-Caren (C [symbol] H [symbol] ) | 136.1 | 1000149-94-6 | 9.7 | 2835154 | 1.0 | 0.2 | 0.22 |
| 1,2,3-Trimethylbenzene | 120.1 | 526-73-8 | 9.7 | 19118825 | 1.0 | 1.6 | 1.6 |
| Isopropyltoluene isomer | 134.1 | 527-84-4 | 9.8 | 43249706 | 1.0 | 3.6 | 3.6 |
| Limonene | 136.1 | 5982-27-5 | 10.0 | 117887898 | 1.0 | 9.9 | 9.9 |
| Indane | 118.1 | 496-11-7 | 10.1 | [symbol] 0 [symbol] 11 | 1.0 | 0. [symbol] | 0.59 |
| beta-Pinene | 136.1 | 12 [symbol] | 10.2 | 2 [symbol] 4 [symbol] | 1.0 | 0.2 | 0.24 |
| Indene | 116.1 | 95-13-6 | 10.3 | 8891588 | 1.0 | 0.7 | 0.73 |
| Diethylbenzene isomer | 134.1 | 141-93-5 | 10.3 | 2163203 | 1.0 | 0.2 | 0.18 |
| Propyltoluene isomer | 134.1 | 1074-43-7 | 10.4 | 3775 [symbol] 5 | 1.0 | 0.3 | 0.32 |
| 2-Methylphenol | 108.1 | 95-48-7 | 10.4 | 3775885 | 1.0 | 0.3 | 0.32 |
| Diethylbenzene isomer | 134.1 | 135-01-3 | 10.5 | 11941905 | 1.0 | 1.0 | 1.0 |
| 1-Methylpropylbenzene | 134.1 | 135-9 [symbol] - [symbol] | 10.7 | 1179 [symbol] 72 | 1.0 | 0.1 | 0.099 |
| 4-Methylphenol | 108.1 | 106-44-5 | 10.9 | 2 [symbol] 73400 | 1.0 | 0.2 | 0.23 |
| Dimethylethylbenzene | 134.1 | 934-80- [symbol] | 10.9 | 11 [symbol] | 1.0 | 0.1 | 0.10 |
| Isopropyltoluene isomer | 134.1 | 99-87-6 | 11.0 | [symbol] 39143 | 1.0 | 0.6 | 0.50 |
| 2-Propenyltoluene | 132.1 | 1587-04-8 | 11.1 | 188 [symbol] 02 | 1.0 | 0.2 | 0.16 |
| Dimethylethylbenzene | 1 [symbol] .1 | [symbol] -2 | 11.1 | 4 [symbol] 002 [symbol] 3 | 1.0 | 0.4 | 0.38 |
| 4-Carene (C [symbol] H [symbol] ) | 136.1 | 2 [symbol] 50-33-7 | 11.1 | [symbol] 1 [symbol] 227 [symbol] | 1.0 | 0. [symbol] | 0.52 |
| Isopropyltoluene isomer | 134.1 | [symbol] 35-77-3 | 11.2 | 1322 [symbol] 3 | 1.0 | 0.1 | 0.11 |
| Isopropenyltoluene isomer | 132.1 | 11 [symbol] 5-32-0 | 11.2 | 1 [symbol] 347157 | 1.0 | 1.4 | 1.4 |
| Dimethylstyrene isomer | 132.1 | 20 [symbol] 9-89-6 | 11.3 | 19 [symbol] 7732 | 1.0 | 0.2 | 0.17 |
| Isobutyltoluene isomer | 148.1 | 5161-04-6 | 11.4 | 7327754 | 1.0 | 0.6 | 0.62 |
| [symbol] -butyltoluene isomer | 148.1 | 1595-16-0 | 11.6 | 3845593 | 1.0 | 0.3 | 0.32 |
| 1,2,4,5-Tetromethylbenzene | 134.1 | 93-93-2 | 11.7 | 1945783 | 1.0 | 0.2 | 0.16 |
| 1,2,3,4-Tetramethylbenzene | 134.1 | 488-23-3 | 11.8 | 5472977 | 1.0 | 0.5 | 0.46 |
| 2-Propenyltoluene | 132.1 | 3111-13-9 | 11.9 | 1256727 | 1.0 | 0.1 | 0.11 |
| C [symbol] H [symbol] | 146.1 | 9 [symbol] 664-18-1 | 11.9 | 2207333 | 1.0 | 0.2 | 0.19 |
| Dimethylstyrene isomer | 132.1 | 2234-20-0 | 12.0 | 3011994 | 1.0 | 0.3 | 0.25 |
| C [symbol] H [symbol] | 148.1 | 4706-89-2 | 12.1 | 2832987 | 1.0 | 0.2 | 0.24 |
| Methylindane isomer | 132.1 | 824-22-6 | 12.2 | 6648032 | 1.0 | 0.6 | 0.58 |
| Methylindane isomer | 132.1 | 767-58-8 | 12.3 | 4641499 | 1.0 | 0.4 | 0.41 |
| Methylindane isomer | 130.1 | 2177-47-1 | 12.4 | 4841499 | 1.0 | 0.4 | 0.41 |
| Methylindane isomer | 130.1 | 768-39-9 | 12.4 | 5825399 | 1.0 | 0.5 | 0.49 |
| Methylindane isomer | 130.1 | 767-60-2 | 12.5 | 4429442 | 1.0 | 0.4 | 0.37 |
| C [symbol] H [symbol] | 130.1 | 2288-18-8 | 12.5 | 4939348 | 1.0 | 0.4 | 0.42 |
| Methylbenzyl Alcohol isomer | 122.1 | 89-95-2 | 12.6 | 728235 | 1.0 | 0.1 | 0.06 |
| C [symbol] H [symbol] | 130.1 | 18677-18- [symbol] | 12.7 | 1950332 | 1.0 | 0.2 | 0.16 |
| C [symbol] H [symbol] | 148.1 | 2049-95-8 | 12.8 | 2077745 | 1.0 | 0.2 | 0.18 |
| C [symbol] H [symbol] | 146.1 | 30253-64-8 | 12.9 | 3843215 | 1.0 | 0.3 | 0.32 |
| C [symbol] H [symbol] | 146.1 | [symbol] | 13.0 | 1198738 | 1.0 | 0.1 | 0.10 |
| Naphthalene | 128.1 | 91-20-3 | 13.0 | 9881450 | 1.0 | 0.8 | 0.83 |
| C [symbol] H [symbol] | 146.1 | 17059-18-2 | 13.1 | 5233251 | 1.0 | 0.4 | 0.44 |
| t-Indecene | 168.2 | 112-41-4 | 13.1 | 4617824 | 1.0 | 0.4 | 0.39 |
| Dimethyliudane isomer | 146.1 | 17057-82-8 | 13.2 | 5935488 | 1.0 | 0.5 | 0.50 |
| C₆-Alkylbenzene | 162.1 | 55669-88-0 | 13.3 | 3536789 | 1.0 | 0.3 | 0.30 |
| C₆-Alkyl [symbol] phene | 168.1 | 54411-06-02 | 13.4 | 818139 | 1.0 | 0.1 | 0.052 |
| C₆-Alkylbenzene | 162.1 | 102-25-0 | 13.4 | 1033573 | 1.0 | 0.1 | 0.087 |
| C [symbol] H [symbol] | 146.1 | 53173-84-2 | 13.6 | 280994 [symbol] | 1.0 | 0.3 | 0.32 |
| Benzothiazol | 135.1 | 93-16-9 | 13.7 | 13896905 | 1.0 | 1.2 | 1.2 |
| Methyltetralin | 146.1 | 2809-63-5 | 13.8 | 3054492 | 1.0 | 0.3 | 0.26 |
| Trimethylindane isomer | 160.1 | [symbol] 50-4 [symbol] | 13.9 | 149 [symbol] 422 | 1.0 | 0.1 | 0.13 |
| Trimethylindane isomer | 160.1 | 2613-76-5 | 14.0 | 4623297 | 1.0 | 0.4 | 0.39 |
| Ethylindene | 144.1 | 17059-50-6 | 14.0 | 189 [symbol] 451 | 1.0 | 0.2 | 0.16 |
| Dimethylindane isomer | 146.1 | 6682-21-9 | 14.1 | 2496416 | 1.0 | 0.2 | 0.21 |
| Dimethylindane isomer | 144.1 | 2177-48-2 | 14.2 | 7888120 | 1.0 | 0.6 | 0.65 |
| Dimethylindane isomer | 144.1 | 4773-82-4 | 14.3 | 7847943 | 1.0 | 0.7 | 0.66 |
| Dimethylindane isomer | 144.1 | 18636-55-0 | 14.3 | 11844 [symbol] 09 | 1.0 | 0.2 | 0.16 |
| Methyldihydronaphthalene | 144.1 | 2717- [symbol] | 14.4 | 7759814 | 1.0 | 0.7 | 0.65 |
| C [symbol] H [symbol] | 158.1 | 1605- [symbol] -1 | 14.6 | 3043127 | 1.0 | 0.3 | 0.26 |
| t-Tridecene | 132.2 | 2437-56-1 | 14.7 | 3447104 | 1.0 | 0.3 | 0.29 |
| Dimethyltetralio isomer | 160.1 | 25419-33-4 | 14.8 | 2955215 | 1.0 | 0.2 | 0.25 |
| Tridecane | 1 [symbol] .2 | [symbol] | 14.9 | 3527337 | 1.0 | 0.3 | 0.30 |
| Methylbenzothiazole | 149.1 | 120-7 [symbol] -21 | 14.9 | 3030000 | 1.0 | 0.3 | 0.26 |
| 2-Methylnaphthalene | 142.1 | 9 [symbol] | 14.9 | 7000927 | 1.0 | 0. [symbol] | 0.59 |
| Trimethylindene isomer | 158.1 | 4773-83-5 | 14.9 | 1041792 | 1.0 | 0.1 | 0.088 |
| Trimethylindene isomer | 157.1 | 2177-43-9 | 15.0 | 1550858 | 1.0 | 0.1 | 0.13 |
| C [symbol] H [symbol] | 1 [symbol] .2 | 1 [symbol] | 15.1 | 2210800 | 1.0 | 0.2 | 0.19 |
| 1-Methylnaphthalene | 142.1 | 99-42-0 | 15.1 | 5709506 | 1.0 | 0.5 | 0.48 |
| C [symbol] H [symbol] | 1 [symbol] .1 | 14679-13-1 | 15.2 | 823877 | 1.0 | 0.1 | 0.069 |
| Dimethyl [symbol] isomer | 160.1 | 417 [symbol] 4-6 | 15.3 | 1 [symbol] 01810 | 1.0 | 0.1 | 0.13 |
| Dimethyl [symbol] isomer | 160.1 | | 15.6 | 15228 [symbol] | 1.0 | 0.1 | 0.13 |
| Trimethylindene isomer | 158.1 | | 15.9 | 1591819 | 1.0 | 0.1 | 0.13 |
| Trimethylindene isomer | 158.1 | | 15.9 | 18 [symbol] 02 | 1.0 | 0.2 | 0.16 |
| Trimethylindene isomer | 158.1 | | 16.0 | 8413027 | 1.0 | 0.7 | 0.71 |
| Trimethylindene isomer | 158.1 | | 16.1 | 19691 [symbol] | 1.0 | 0.3 | 0.25 |
| Biphenyl | 154.1 | 92- [symbol] | 16.2 | 2280514 | 1.0 | 0.2 | 0.19 |
| 1-Tetradecene | 196.2 | 1129 [symbol] | 16.2 | 2584825 | 1.0 | 0.2 | 0.22 |
| Dimethylbenzothiophene | 162.3 | 16537-48-7 | 16.3 | 1417957 | 1.0 | 0.1 | 0.12 |
| Tetradecane | 198.2 | 629-59-4 | 16.3 | 2581 [symbol] 58 | 1.0 | 0.2 | 0.22 |
| Ethylnaphthalene | 156.1 | 1127-76-0 | 16.4 | 2518092 | 1.0 | 0.3 | 0.30 |
| Dimethylnaphthalene | 156.1 | 571-61-9 | 16.5 | 52 [symbol] 0203 | 1.0 | 0.4 | 0.44 |
| Dimethylnaphthalene | 156.1 | 582-15-1 | 16.6 | 3879870 | 1.0 | 0.3 | 0.33 |
| Dimethylnaphthalene | 156.1 | [symbol] | 16.7 | 7553377 | 1.0 | 0.8 | 0.64 |
| Dimethylnaphthalene | 156.1 | [symbol] -98-8 | 16.8 | 13401456 | 1.0 | 1.1 | 1.1 |
| [symbol] -Alkylthiophene | 210.3 | 5295-09-7 | 17.0 | 203061 | 1.0 | 0.0 | 0.042 |
| Dimethylquinoline | 157.1 | 877-43-0 | 17.0 | 10 [symbol] 04408 | 1.0 | 0.9 | 0.89 |
| C [symbol] H [symbol] | 204.2 | 470-40-8 | 17.1 | 1536044 | 1.0 | 0.1 | 0.13 |
| C [symbol] H [symbol] | 138.1 | 74629-29-8 | 17.2 | 1199 [symbol] 59 | 1.0 | 0.1 | 0.10 |
| Dimethylnaphthalene | 156.1 | 581-42-0 | 17.2 | 4887279 | 1.0 | 0.4 | 0.41 |
| C [symbol] H [symbol] | 206.2 | 1000156-14-5 | 17.3 | 39 [symbol] 33 [symbol] 1 | 1.0 | 0.3 | 0.34 |
| C [symbol] H [symbol] | 202.2 | 644-36-4 | 17.4 | 1859034 | 1.0 | 0.2 | 0.16 |
| C [symbol] H [symbol] | 202.2 | 1 [symbol] | 17.5 | 3687555 | 1.0 | 0.3 | 0.31 |
| Methylbiphenyl | 168.1 | 644-08-0 | 17.6 | 6414984 | 1.0 | 0.5 | 0.54 |
| Pentadecane | 212.3 | 629-62-9 | 17.7 | 4359249 | 1.0 | 0.4 | 0.37 |
| Methyl [symbol] phenyl | 168.1 | 643-38-3 | 17.8 | 2080829 | 1.0 | 0.2 | 0.18 |
| Trimethylnaphthalene | 170.1 | 224 [symbol] -38-7 | 17.9 | 4298830 | 1.0 | 0.4 | 0.36 |
| C [symbol] H [symbol] | 206.2 | 13567-54-9 | 18.0 | 5332439 | 1.0 | 0.4 | 0.45 |
| C [symbol] H [symbol] | 202.2 | 644-30-4 | 17.4 | 1 [symbol] 9034 | 1.0 | 0.2 | 0.16 |
| C [symbol] H [symbol] | 202.2 | 16982-00-6 | 17.5 | 2 [symbol] 7 [symbol] | 1.0 | 0.3 | 0.31 |
| Methyl [symbol] phenyl | 168.1 | 644-08-6 | 17.6 | [symbol] 414084 | 1.0 | 0.5 | 0.64 |
| Petadecane | 212.3 | 629-62-9 | 17.7 | 4359249 | 1.0 | 0.4 | 0.37 |
| Methyl [symbol] phenyl | 168.1 | 643-58-3 | 17.8 | 2080829 | 1.0 | 0.2 | 0.18 |
| Trimethylnaphthalene | 170.1 | 2215-38-7 | 17.9 | 4298890 | 1.0 | 0.4 | 0.36 |
| C [symbol] H [symbol] | 206.2 | 13567-54-9 | 18.0 | 5332739 | 1.0 | 0.4 | 0.45 |
| Trimethylnaphthalene | 170.1 | 829-26-5 | 18.1 | 1701185 | 1.0 | 0.1 | 0.14 |
| Trimethylnaphthalene | 170.1 | 2131-42-2 | 18.2 | 1296367 | 1.0 | 0.1 | 0.12 |
| Trimethylnaphthalene | 170.1 | 2131-41-1 | 18.3 | 13860227 | 1.0 | 1.2 | 1.2 |
| Trimethylazulene | 170.1 | 941-81-1 | 18.5 | 4254817 | 1.0 | 0.4 | 0.36 |
| Trimethylnaphthalene | 170.1 | | 18.5 | 3 [symbol] 7 [symbol] 305 | 1.0 | 0.3 | 0.33 |
| Trimethylnaphthalene | 170.1 | | 18.7 | 3224042 | 1.0 | 0.3 | 0.27 |
| Trimethylnaphthalene | 170.1 | | 18.7 | 4317387 | 1.0 | 0.4 | 0.36 |
| Dimethylbiphenyl | 182.1 | [symbol] | 18.8 | 935 [symbol] 0 [symbol] | 1.0 | 0.1 | 0.079 |
| C₁₄H₁₆ | 184.1 | 490 [symbol] | 18.9 | 2280193 | 1.0 | 0.2 | 0.19 |
| 1-Hexadecene | 224.3 | 629-73-2 | 18.9 | 2250193 | 1.0 | 0.2 | 0.19 |
| C₃-Alkylbenzothiophene | 196.3 | 18428-0 [symbol] | 18.9 | 1120193 | 1.0 | 0.2 | 0.19 |
| Hexadecane | 226.3 | 544-76-3 | 19.0 | 4903997 | 1.0 | 0.4 | 0.41 |
| Dimethylbiphenyl | 182.1 | 612-75-9 | 19.1 | 2702535 | 1.0 | 0.2 | 0.23 |
| Isopropenylnaphthalene | 168.1 | 1855-47-6 | 19.2 | 1 [symbol] 09092 | 1.0 | 0.1 | 0.11 |
| 2-Methylthibenzothiazole | 181.4 | 615-22-5 | 19.2 | 4014 [symbol] 41 | 1.0 | 0.3 | 0.34 |
| 1,1-Diphenylpropane | 184.1 | 530-56-7 | 19.4 | 4267 [symbol] 4 | 1.0 | 0.4 | 0.36 |
| Tetramethylnaphthalene | 184.1 | 3031-13-0 | 19.5 | 4013 [symbol] 2 | 1.0 | 0.0 | 0.034 |
| Triethylacetophenone | 204.2 | [symbol] | 19.6 | 33 [symbol] 1 [symbol] 78 | 1.0 | 0.3 | 0.28 |
| 1,3-Diphenylpropane | 196.1 | 1081-75-0 | 19.8 | 2011 [symbol] 7 | 1.0 | 0.2 | 0.17 |
| Benzothiazolane | 151.2 | 934-34-9 | 20.0 | [symbol] 00039 | 1.0 | 0.1 | 0.076 |
| Tetramethylnaphthalene | 184.1 | | 20.0 | [symbol] | 1.0 | 0.0 | 0.047 |
| C₅-Alkylnaphthalene | 198.1 | 483-78-3 | 20.0 | 1055590 | 1.0 | 0.1 | 0.089 |
| C₄-Alkylbezothiophene | 190.1 | 18428-0 [symbol] | 20.1 | 478555 | 1.0 | 0.0 | 0.040 |
| 1-Heptadecene | 238.3 | 6765-39-5 | 20.2 | 13 [symbol] 0 [symbol] | 1.0 | 0.1 | 0.11 |
| Tetramethylnaphthalene | 184.1 | | 20.2 | 488308 | 1.0 | 0.0 | 0.041 |
| Heptadecane | 240.3 | 629-78-7 | 20.2 | 8676594 | 1.0 | 0.7 | 0.73 |
| C [symbol] H [symbol] O | 181.1 | 613-37-6 | 20.3 | 122 [symbol] 5 | 1.0 | 0.0 | 0.010 |
| Methylfluorene | 180.1 | 1430-97- [symbol] | 20.4 | 1061198 | 1.0 | 0.1 | 0.089 |
| Methylfluorene | 180.1 | [symbol] -99-6 | 20.4 | 1248992 | 1.0 | 0.1 | 0.11 |
| Methylfluorene | 180.1 | 1736-37-6 | 20.5 | 2032190 | 1.0 | 0.2 | 0.17 |
| Tetramethylnaphthalene | 184.1 | | 20.6 | 3095786 | 1.0 | 0.3 | 0.26 |
| Diphenylamine | 183.1 | 552-82-9 | 20.7 | 924449 | 1.0 | 0.1 | 0.078 |
| Dimethylbiphenyl | 182.1 | 611-43-8 | 20.7 | 1230 [symbol] 5 | 1.0 | 0.1 | 0.10 |
| Dimethylbiphenyl | 182.1 | 611-81-0 | 20.8 | 518781 | 1.0 | 0.0 | 0.044 |
| C₃-Alkylbiphenyl | 196.1 | [symbol] -2 | 20.9 | 2325848 | 1.0 | 0.2 | 0.20 |
| Dimethylbiphenyl | 182.1 | 6 [symbol] -2 | 21.0 | [symbol] 14550 | 1.0 | 0.1 | 0.52 |
| 1-Octadecane | 252.3 | 112-88-9 | 21.3 | 1499142 | 1.0 | 0.1 | 0.13 |
| Octadecane | 254.3 | 503-45-3 | 21.4 | 216234 [symbol] | 1.0 | 0.2 | 0.18 |
| Phenanthrene | 178.1 | 83-01-8 | 21.4 | 5229720 | 1.0 | 0.4 | 0.44 |
| Anthracene | 178.1 | 120-12-7 | 21.6 | 896391 | 1.0 | 0.1 | 0.076 |
| Methyldihydroanthracene | 194.1 | [symbol] -67-4 | 21.7 | 1600546 | 1.0 | 0.1 | 0.13 |
| Dimethylfluorene | 194.1 | 4612-63-9 | 21.8 | 1923266 | 1.0 | 0.2 | 0.16 |
| alpha-Methylstilbene | 194.1 | 833-81-8 | 21.8 | 1837222 | 1.0 | 0.2 | 0.15 |
| C₁₄H₂₄ | 192.2 | 1000149- [symbol] -0 | 21.9 | 1272873 | 1.0 | 0.1 | 0.11 |
| C [symbol] H [symbol] | 196.1 | 28122-28-3 | 22.0 | 929810 | 1.0 | 0.1 | 0.078 |
| C [symbol] H [symbol] | 196.1 | 620-85-9 | 22.0 | 1938841 | 1.0 | 0.2 | 0.16 |
| C [symbol] H [symbol] | 196.1 | 28122-27-2 | 22.1 | 1147494 | 1.0 | 0.1 | 0.10 |
| Phenylnaphthalene | 204.1 | 605-02-7 | 22.2 | 908407 | 1.0 | 0.1 | 0.077 |
| C₃-Alkylbiphenyl | 196.1 | 20282-30-8 | 22.3 | 532415 | 1.0 | 0.0 | 0.045 |
| 1-Nonadecene | 266.3 | 18435-45-5 | 22.4 | 839315 | 1.0 | 0.1 | 0.054 |
| Nonadecane | 268.3 | 629-92-5 | 22.6 | 9480667 | 1.0 | 0.3 | 0.29 |
| Methylanthracene | 192.1 | 610-48-0 | 22.7 | 2808482 | 1.0 | 0.2 | 0.24 |
| Methylanthracene | 192.1 | 779-02-2 | 22.8 | 3021632 | 1.0 | 0.3 | 0.25 |
| C [symbol] H [symbol] | 208.3 | 2919-20-2 | 22.8 | 948882 | 1.0 | 0.1 | 0.080 |
| Methylanthracene | 192.1 | 613-12-7 | 23.0 | 3295304 | 1.0 | 0.3 | 0.28 |
| Hexadecanoic Acid | 156.2 | 57-10-3 | 23.1 | 1608808 | 1.0 | 0.1 | 0.14 |
| Phenylnaphthalene | 204.1 | 1 [symbol] -71-5 | 23.6 | 2413949 | 1.0 | 0.2 | 0.20 |
| No ID 239/41 ( [symbol] ) | 239.5 | | 23.6 | 2598804 | 1.0 | 0.3 | 0.30 |
| Dimethylphenanthrene | 206.1 | 3674-69-9 | 23.8 | 1390248 | 1.0 | 0.1 | 0.12 |
| C [symbol] H [symbol] | 256.2 | 1000197-14-1 | 23.9 | 2135857 | 1.0 | 0.2 | 0.18 |
| Dimethylanthracene | 206.1 | 781-43-1 | 24.1 | 1797545 | 1.0 | 0.2 | 0.15 |
| Dimethylphenanthrene | 206.1 | 1576-67-6 | 24.2 | 1204255 | 1.0 | 0.1 | 0.10 |
| Dimethylanthracene | 206.1 | 781-43-1 | 24.1 | 1797545 | 1.0 | 0.2 | 0.15 |
| Dimethylphenanthrene | 206.1 | 1576-67-6 | 24.2 | 1204255 | 1.0 | 0.1 | 0.10 |
| Dimethylphenanthrene | 206.1 | 1576-69-8 | 24.3 | 1308936 | 1.0 | 0.1 | 0.11 |
| Butylated Hydroxyuluene | 220.2 | 128-37-0 | 24.6 | 709253 | 1.0 | 0.1 | 0.060 |
| [symbol] | 202.1 | 208-44-0 | 24.6 | 709253 | 1.0 | 0.1 | 0.060 |
| Henetcosane | 296.3 | 629-94-7 | 24.5 | 501507 | 1.0 | 0.0 | 0.042 |
| Hexadecanenitrile | 251.3 | 5399-02-0 | 24.6 | 2270476 | 1.0 | 0.2 | 0.19 |
| 2-Propenylanthracene | 218.1 | 23707-65-5 | 24.7 | 434906 | 1.0 | 0.0 | 0.037 |
| Diisoproplybiphenyl | 238.2 | 69009-90-1 | 24.7 | 434906 | 1.0 | 0.0 | 0.37 |
| Pyrene | 202.1 | 129-00-0 | 25.0 | 1101445 | 1.0 | 0.1 | 0.93 |
| Trimethylphenanthrene | 220.1 | 3674-73-5 | 25.3 | 12419608 | 1.0 | 0.1 | 0.11 |
| D [symbol] | 310.4 | 629-97-0 | 25.5 | 548465 | 1.0 | 0.0 | 0.046 |
| C₄-Alkylphenanthrene | 234.1 | 483-65-8 | 25.9 | 4403417 | 1.0 | 0.4 | 0.37 |
| Tricosane | 324.4 | 638-67-5 | 26.4 | 393836 | 1.0 | 0.0 | 0.033 |
| No ID m/c 211, 268 | 268.2 | | 27.0 | 435605 | 1.0 | 0.0 | 0.037 |
| Tetracosane | 338.4 | 648-31-1 | 27.3 | 357880 | 1.0 | 0.0 | 0.030 |
| Chrysene | 228.1 | 218-01-0 | 28.1 | 241570 | 1.0 | 0.0 | 0.020 |
| Pentacosane | 352.4 | 629-99-2 | 28.2 | 301841 | 1.0 | 0.0 | 0.025 |
| Benz[a]anthracene | 228.1 | 50-55-3 | 28.2 | 250000 | 1.0 | 0.0 | 0.021 |

[symbol]

indicates data missing or illegible when filed

In one embodiment, the compositions of the application are those having a general formulation:
Tire Pyrolysis Oil present at a concentration of from about 0.1 to about 95 volume percent (In some embodiments the Tire Pyrolysis Oil is present at a concentration of from about 2.5 to about 80 percent. In other embodiments, the Tire Pyrolysis Oil is present a concentration of from about 10 to about 40 percent);
Diesel oil present at a concentration of from about 0 to about 30 volume percent (In some embodiments the Diesel oil is present at a concentration of from about 5 to about 25 percent. In other embodiments, the Diesel oil is present a concentration of from about 10 to about 20 percent);
Terpenes present at a concentration of from about 0 to about 80 volume percent (In some embodiments the Terpenes are present at a concentration of from about 2.5 to about 70 percent. In other embodiments, the Terpenes are present a concentration of from about 10 to about 50 percent);
Limonene present at a concentration of from about 0 to about 60 volume percent (In some embodiments the Limonene is present at a concentration of from about 2.5 to about 50 percent. In other embodiments, the Limonene is present a concentration of from about 10 to about 40 percent);
Acidifying Compounds selected from the group consisting of Mineral Acids; Organic Acids; Synthetic Acids; and combinations thereof present at a concentration of from about 0 to about 35 volume percent (In some embodiments the Acidifying Compounds are present at a concentration of from about 2.5 to about 30 percent. In other embodiments, the Acidifying Compounds are present a concentration of from about 5 to about 25 percent);
Nano Surfactants present at a concentration of from about 0 to about 5 volume percent where the Nano Surfactants are nonionic surfactants having very small micelles which may or may not include nanoparticles of carbon (In some embodiments the Nano Surfactants are present at a concentration of from about 1 to about 4 percent. In other embodiments, the Nano Surfactants are present a concentration of from about 1.5 to about 3 percent);
Carbon Disulfide present at a concentration of from about 0 to about 25 volume percent (In some embodiments the Carbon Disulfide is present at a concentration of from about 2.5 to about 20 percent. In other embodiments, the Carbon Disulfide is present a concentration of from about 5 to about 15 percent);
2-Butoxy Ethanol (a.k.a. Ethylene Glycol Monobutyl Ether) present at a concentration of from about 0 to about 30 volume percent (In some embodiments the 2-Butoxy Ethanol is present at a concentration of from about 2.5 to about 30 percent. In other embodiments, the 2-Butoxy Ethanol is present a concentration of from about 5 to about 25 percent);
Ethylene Glycol Monopropyl Ether present at a concentration of from about 0 to about 20 volume percent (In some embodiments the Ethylene Glycol Monopropyl Ether is present at a concentration of from about 2.5 to about 15 percent. In other embodiments, the Ethylene Glycol Monopropyl Ether is present a concentration of from about 5 to about 10 percent);
Ethylene Glycol present at a concentration of from about 0 to about 20 volume percent (In some embodiments the Ethylene Glycol is present at a concentration of from about 2.5 to about 15 percent. In other embodiments, the Ethylene Glycol are present a concentration of from about 5 to about 10 percent);
Naphtha, Condensate, Debutanized Natural Gasoline, and/or or other diluents (sometimes referred to generally as Diluents) present at a concentration of from 0 to 99 volume percent (In some embodiments the Diluents are present at a concentration of from about 2.5 to about 90 percent. In other embodiments, the Diluents are present a concentration of from about 5 to about 50 percent);
Toluene present at a concentration of from about 0 to about 30 volume percent (In some embodiments the Toluene is present at a concentration of from about 2.5 to about 25 percent. In other embodiments, the Toluene is present a concentration of from about 5 to about 20 percent);
Methanol present at a concentration of from about 0 to about 30 volume percent (In some embodiments the Methanol is present at a concentration of from about 2.5 to about 25 percent. In other embodiments, the Methanol is present a concentration of from about 5 to about 20 percent);
Ethanol present at a concentration of from about 0 to about 30 volume percent (In some embodiments the Ethanol is present at a concentration of from about 2.5 to about 25 percent. In other embodiments, the Ethanol is present a concentration of from about 5 to about 20 percent); and
Xylenes present at a concentration of from about 0 to about 80 volume percent (In some embodiments the Xylenes are present at a concentration of from about 2.5 to about 75 percent. In other embodiments, the Xylenes are present a concentration of from about 5 to about 50 percent).

Tire Pyrolysis Oil may include many of the bullet point materials above. The quantities noted immediately above are in addition to the quantities already present in the in the Tire Pyrolysis Oil.

In another embodiment, the invention is a cleaning agent such as a pipeline cleaner. In embodiments where the composition is a pipeline cleaner, the Tire Pyrolysis Oil may be incorporated at a concentration of from about 15 to about 75% to achieve synergistic properties. In some embodiments the Tire Pyrolysis Oil is present at a concentration of from about 20 to about 65 percent. In other embodiments, the Tire Pyrolysis Oil is present a concentration of from about 25 to about 50 percent. Conventional pipeline cleaning agents include but are not limited to those such as the one disclosed in U.S. Pat. No. 6,176,243 which is incorporated by reference in its entirety.

A conventional pipeline cleaning functional agent could be one similar to: 1 part by weight of Limonene; 9 parts by weight of a glycol ether; 3 parts by weight of an ethoxylated alcohol surfactant; 1 part by weight of an aliphatic alcohol having 1 to 4 carbon atoms or mixtures thereof; and 1 part by weight of a non-hazardous and biodegradable organic acid.

For example, when used for cleaning a crude oil pipeline it can be incorporated into a formulation comprising 40 to 99 vol % of a fatty acid alkyl ester blend and about 1 to 25 vol % of at least one lower alkyl glycol ether, and from about 1 to about 40 vol % Tire Pyrolysis Oil. In some embodiments the Tire Pyrolysis Oil is present at a concentration of from about 2.5 to about 30 percent. In other embodiments, the Tire Pyrolysis Oil are present a concentration of from about 5 to about 25 percent.

In still another embodiment, the composition is a cleaning agent for storage and transportation vessels of any kind, including but not limited to storage tanks, ship holds, railcars, trucks, and other storage units. Cleaning tanks in general, but especially cleaning oil storage tanks and transportation vessels can be complex. U.S. Pat. No. 5,580,391 discloses a process for thermo-chemical cleaning of such storage tanks and is incorporated herein by reference in its entirety. Briefly, this reference discloses a process for the thermo-chemical cleaning of storage tanks which contain sludges from petroleum oil or related products. The process is carried out by the combined action of an organic solvent and the generation of nitrogen gas and heat, whereby produced heating in situ, agitation by turbulence and flotation of the fluidized sludge, which after being collected and transferred to tanks or desalting units can be reintroduced in the usual refining flow.

U.S. Pat. No. 6,168,708 teaches using cleaning crude oil tanks using heat and solvent and is incorporated by reference in its entirety. This reference teaches using an organic solvent is selected from the group consisting of gas oil, diesel oil, heater oil, jet fuel, toluene, cyclohexane, naphtha, and xylenes.

In embodiments where the composition is a tank cleaner, the Tire Pyrolysis Oil may be incorporated at a concentration of from about 15 to about 95% to achieve synergistic properties. In some embodiments the Tire Pyrolysis Oil is present at a concentration of from about 20 to about 75 percent. In other embodiments, the Tire Pyrolysis Oil is present a concentration of from about 25 to about 50 percent. Conventional tank cleaners include but are not limited to those such as the one disclosed in U.S. Pat. No. 5,580,391 which is incorporated by reference in its entirety.

Similarly, in embodiments where the composition is a paraffin inhibitor, asphaltene inhibitor, or scale inhibitor, the Tire Pyrolysis Oil may be incorporated at a concentration of from about 5 to about 95% to achieve synergistic properties.

The compositions of the application may also act as paraffin modifiers and asphaltene modifiers. For the purposes of this application, the term “modifier” is defined to mean, in an application where paraffins and/or asphaltenes have already formed in a system such as a wellbore, a composition which is introduced into the system which causes the already formed paraffins and/or asphaltenes deposits to release from the substrate upon which they were deposited.

In embodiments where the composition is a paraffin inhibitor, the Tire Pyrolysis Oil may be incorporated at a concentration of from about 5 to about 50% to achieve synergistic properties. In some embodiments the Tire Pyrolysis Oil is present at a concentration of from about 2.5 to about 30 percent. In other embodiments, the Tire Pyrolysis Oil is present a concentration of from about 5 to about 25 percent. Conventional paraffin inhibitors include but are not limited to those such as the one disclosed in U.S. Pat. Nos. 7,541,315 and 9,133,046; which are incorporated by reference in their entirety.

Such a paraffin inhibitor may be prepared by admixing a polymer having the characteristic of inhibiting paraffin crystalline growth in formation fluid from oil and gas wells with a first solvent selected from the weak to moderate wax solvents and a second solvent selected from the strong wax solvents. Exemplary weak to moderate strength wax solvents include benzene, toluene, xylene, ethyl benzene, propyl benzene, trimethyl benzene and mixtures thereof. Exemplary strong wax solvents include cyclopentane, cyclohexane, carbon disulfide, decalin and mixtures thereof.

In embodiments where the composition is an asphaltene inhibitor, the Tire Pyrolysis Oil may be incorporated at a concentration of from about 45 to about 95% to achieve synergistic properties. In some embodiments the Tire Pyrolysis Oil is present at a concentration of from about 50 to about 75 percent. In other embodiments, the Tire Pyrolysis Oil is present a concentration of from about 55 to about 65 percent. Conventional asphaltene inhibitors include but are not limited to those such as the one disclosed in U.S. Pat. No. 9,221,803 which is incorporated by reference in its entirety.

Such asphaltene inhibitors can have a formulation including oxazolidine derived from polyalkyl or polyalkenyl N-hydroxyalkyl succinimides. These formulations can contain inert organic solvents, preferably including: toluene, mixed xylenes, ortho-xylene, meta-xylene, para-xylene, kerosene, turbo-fuel; or inert hydrocarbon solvents having boiling points within the range of gasoline and diesel; or inert hydrocarbon or organic solvents having a boiling point within a range from 75 to 300° C. The ratio in weight of inert organic solvents to additive that prevents and controls the precipitation and deposition of asphaltenes ranges from 1:9 to 9:1, preferably from 1:3 to 3:1. Conventional scale inhibitors include but are not limited to those such as the one disclosed in U.S. Pat. No. 9,133,046 which is incorporated by reference in its entirety.

In embodiments where the composition is a scale inhibitor, the Tire Pyrolysis Oil may be incorporated at a concentration of from about 40 to about 75% to achieve synergistic properties. In some embodiments the Tire Pyrolysis Oil is present at a concentration of from about 50 to about 70 percent. In other embodiments, the Tire Pyrolysis Oil is present a concentration of from about 55 to about 75 percent. Conventional scale inhibitors include but are not limited to those such as the one disclosed in U.S. Pat. No. 7,703,516 which is incorporated by reference in its entirety.

Such scale inhibitors can have a composition having an acrylic acid 2-acrylamido-2-methylpropyl sulfonic acid copolymer, combined with a synergistically effective amount of oligomeric phosphinosuccinic acid or a mono, bis, and oligomeric phosphinosuccinic acid adduct.

In embodiments of the invention where the functional agent is a corrosion inhibitor, it may be any known to be useful to those of ordinary skill in the art such as those disclosed in U.S. Pat. No. 10,808,165 the contents of which is incorporated by reference in its entirety. Such corrosion inhibitors include alkyldiphenyloxide disulfonates in their formulation.

Alternatively, in some embodiments, Tire Pyrolysis Oil itself may be employed as the continuous phase and/or dominant phase of a corrosion inhibitor. In such embodiments, the corrosion inhibitor will be about 100% Tire Pyrolysis Oil. It has been found that a small amount of a non-ionic surfactant, especially a Nano Surfactant in a range of from about 1 to about 10 volume percent can be desirable.

In an embodiment where the composition is a stimulation fluid, the Tire Pyrolysis Oil may be employed in ranges of from about 40 to about 95% by volume to synergistic effect. Such fluids are disclosed in U.S. Pat. Nos. 8,778,850, and the like. This reference is incorporated herein by reference in its entirety. In some embodiments the Tire Pyrolysis Oil is present at a concentration of from about 45 to about 80 percent. In other embodiments, the Tire Pyrolysis Oil is present a concentration of from about 50 to about 75 percent.

Exemplary of such stimulation fluids are those having a formulation of a water-miscible and biodegradable solvent for vegetable oil-derived fatty acids; and at least one surfactant, wherein the at least one surfactant is the product of saponification of at least one C8-C20 fatty acid by an amino alcohol; and wherein the fluid droplet size is comprised between 5 and 50 nm.

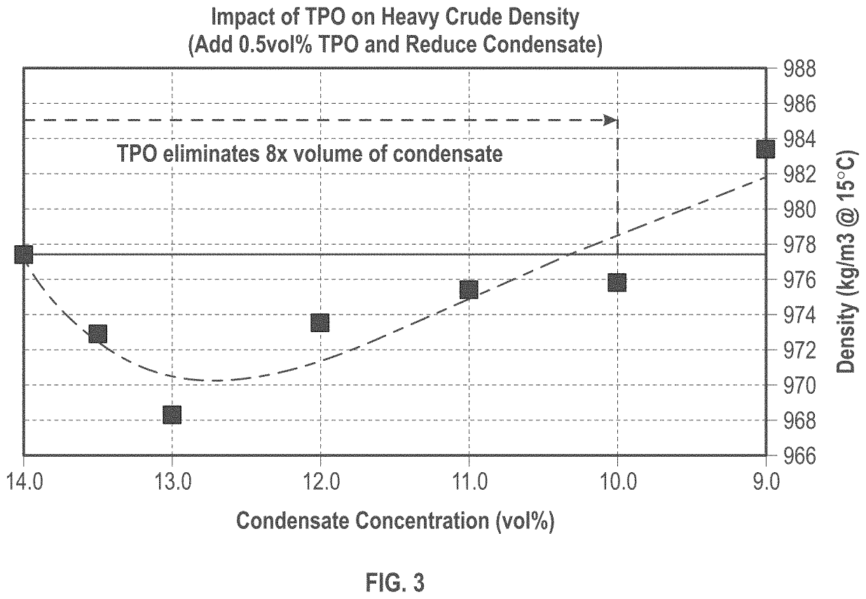

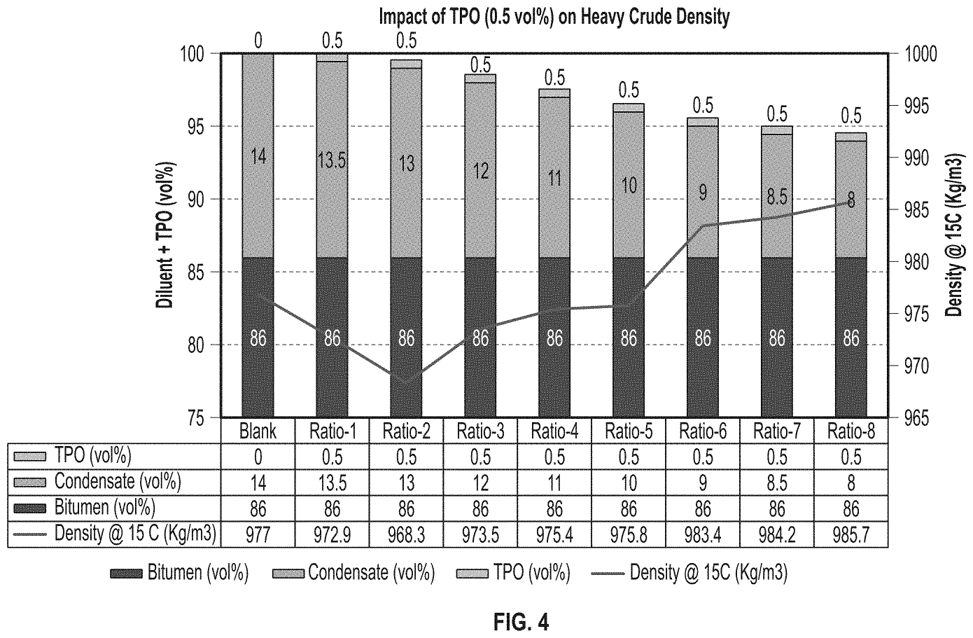

A density improver is also an embodiment of the invention. The Tire Pyrolysis Oil of the application may be employed with a diluent, such as naphtha or condensate to reduce crude oil density. The ratio of both the Tire Pyrolysis Oil and the diluent may be adjusted to achieve a desired density and/or reduction of diluent volume. This aspect of the invention is illustrated in FIG. 3 and FIG. 4.

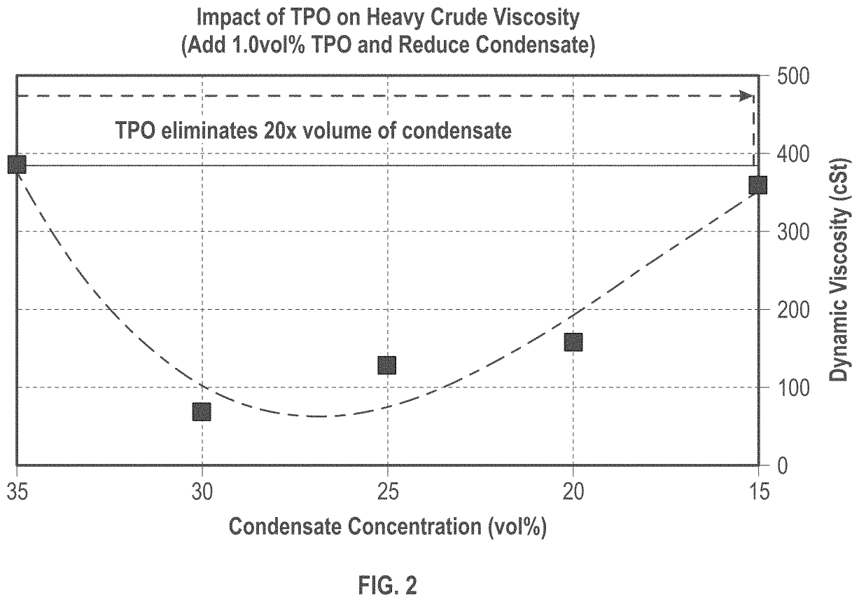

In another embodiment, the invention is a process for reducing the viscosity of crude oil comprising introducing a diluent such as naphtha or condensate into heavy crude oil wherein the diluent and crude mixture is modified with 1.0 volume percent of Tire Pyrolysis Oil. This aspect of the invention is illustrated in FIG. 2.

When the composition is a crude oil viscosity reducer, the Tire Pyrolysis Oil may be employed in ranges of from about 0.5 to about 99 volume percent to synergistic effect. Nano Surfactants may also be employed with these embodiments. In some embodiments the Tire Pyrolysis Oil is present at a concentration of from about 5 to about 75 percent. In other embodiments, the Tire Pyrolysis Oil are present a concentration of from about 10 to about 50 percent. Even more surprising, the use of Tire Pyrolysis Oil can have more impact when used to reduce the viscosity of bitumen or heavy crude oil. For the purposes of this application, the term “Heavy Crude Oil” is defined to mean crude oil having high levels of bitumen. This definition is mean to be consistent with the generally accepted industry description of having an API gravity less than 20°. In some embodiments, the Tire Pyrolysis Oil may have a substantial impact upon the ability of diluents, such as naphtha or condensate, to lower viscosity in Heavy Crude Oil at levels as low as 0.4 volume percent. In other embodiments, the concentration of Tire Pyrolysis Oil needed may be as low as 0.3 volume percent. In still other embodiments, the concentration of Tire Pyrolysis Oil needed may be as low as 0.2 volume percent. And in yet still other embodiment, the concentration of Tire Pyrolysis Oil needed may be as low as 0.1 volume percent.

Another aspect of such applications of Tire Pyrolysis Oil in reducing the viscosity of Heavy Crude Oil is that the optimum concentration of Tire Pyrolysis Oil in a diluent may be parabolic at surprisingly low levels as well. For example, in one embodiment, the maximum reduction in viscosity may be seen at a concentration of about 1.3 volume percent Tire Pyrolysis Oil in diluent, but increasing the concentration of the Tire Pyrolysis further may be counter-productive by reducing the effectiveness of the Tire Pyrolysis Oil in reducing Heavy Crude Oil viscosity.

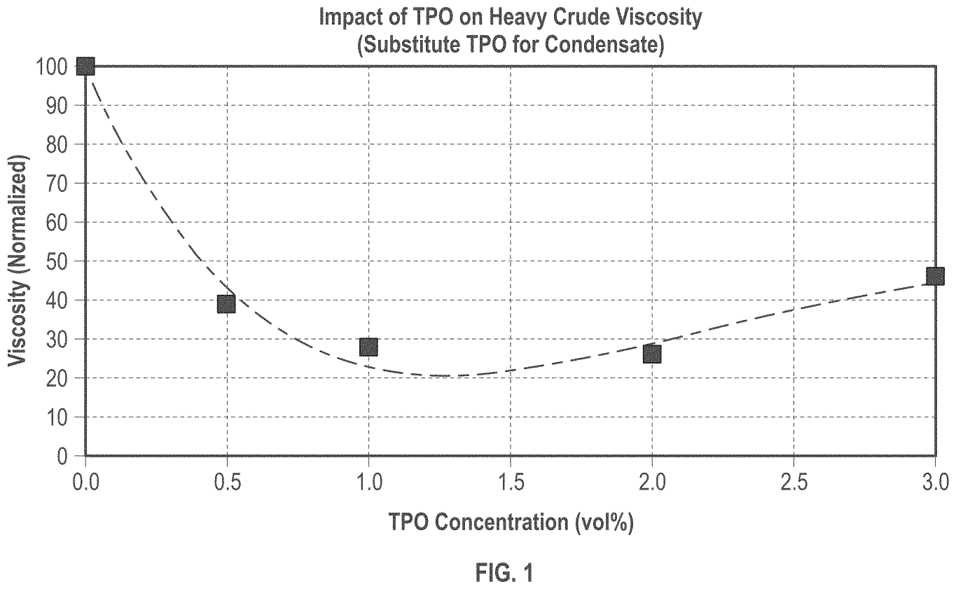

FIG. 1 shows the relationship between substituting small amounts of Tire Pyrolysis Oil for condensate used as diluent for Heavy Crude Oil and the resulting normalized viscosity of the Heavy Crude Oil. This figure is discussed further at Example 10.

FIG. 2 is a graph illustrating the improvement observed with using 1 volume percent Tire Pyrolysis Oil on viscosity. This figure is discussed further at Example 10.

FIG. 3 is a graph illustrating the improvement observed with using 0.5 volume percent Tire Pyrolysis Oil on density. This figure is discussed further at Example 10.

FIG. 4 is a graph illustrating the improvement observed in using Tire Pyrolysis Oil and condensate to reduce crude oil density. This figure is discussed further at Example 10.

### EXAMPLES

### Example 1

### Pipeline Cleaner

A composition is prepared by admixing 46 volume percent Tire Pyrolysis Oil, 15 volume percent #2 Diesel, 15 volume percent ethanol, 2 volume percent Terpenes, 20 volume percent hydrochloric acid, and 2% Nano Surfactant.

A 6-inch pipeline approximately 10 miles long which was used to daily transport 28 API gravity crude oil with heavy asphaltene concentration from seven producing oil wells to a CGF a (common gathering facility) is treated with the composition. The pipeline, prior to treatment, had a sludge buildup such that the inner diameter of the pipeline had been reduced to about 4.5 inches.

Each well is treated with 10 gallons per day of the composition and normal production continued. The treatment is performed for 5 days at ambient temperature. Upon visual inspection at the end of the five-day period, the inner wall of the pipe is found to be clean with no buildup of sludge. The treatment volume is then reduced to 1 gallon per well per day to prevent accumulation of sludge.

### Example 2

### Tank Cleaner

A composition is prepared by admixing 92 volume percent Tire Pyrolysis Oil, 3 volume percent Terpenes, 2 volume percent hydrochloric acid, and 3 volume percent Nano Surfactant.

A 400-barrel tank which receives crude oil from 22 stripper wells, all producing by artificial lift using pump jacks, is treated with the composition. The tank contains a 3-foot sludge bottom containing paraffin, asphaltene, and water (about 60 barrels in volume). The sludge is tested and has a water content of about 30%.

The tank is treated by introducing approximately 2 gallons of the composition through the top of the tank and then circulating the contents of the tank by pumping the contents of tank from the bottom valve of tank and returning it into the top inspection hatch of the tank. The tank is circulating for eight hours and then allowed to settle for 16 hours.

The content of the tank is tested and shown to be oil and water in two phases with the oil phase having a basic sediment and water content of 1.1%.

### Example 3

### Paraffin Inhibitor

A composition is prepared by admixing 15 volume percent Tire Pyrolysis Oil, 15 volume ethanol, 68 volume percent Terpenes, and 2 volume percent Nano Surfactant.

A 2-inch flowline from a pump jack well producing paraffinic oil and saltwater at a daily volume of 16 barrels of oil and 64 barrels of salt water is treated with the composition. The flow line was continually plugging up with paraffins. A separator downstream from the well is also accumulating large amounts of a waxy solid paraffin.

A chemical pump was to pump 0.5 gallons of the composition per day into the flow line for 30 days. After 30 days, both the flow line and the accumulator are free of observable paraffins. This is a very effective way to deal with a problem that would otherwise require an expensive and dangerous procedure of heating crude oil and recirculating it through areas of paraffin build up.

### Example 4

### Scale Inhibitor

A composition is prepared by admixing 66 volume percent Tire Pyrolysis Oil, 68 volume percent Terpenes, 30 volume percent hydrochloric acid, and 3 volume percent Nano Surfactant.

An oil well which is prone to scale problems and producing about 6 barrels of oil and 194 barrels of water per day is treated with the composition to reduce scale. 110 gallons of the composition is introduced into the well followed by 16 barrels of oil. The well is shut in for 24 hours and production resumed. After the treatment, the well produces 9.6 barrels of oil per day.

### Example 5

### Asphaltene Inhibitor

A composition is prepared by admixing 70 volume percent Tire Pyrolysis Oil, 15 volume percent #2 Diesel, 10 volume percent Terpenes, 2 volume percent hydrochloric acid, and 3 volume percent Nano Surfactant.

Ninety Stripper wells producing from 0.1 to 0.8 barrels of 32 API gravity oil are treated with the composition. The wells are approximately 40 years old and asphaltene precipitation from oil worsens as oil production declines. All wells also have very low bottom hole pressure requiring lift to be provided by employing pump jacks.

Each well was treated with 25 gallons of the composition by introducing the composition and 3 barrels of into the well bore and the well is shut in for 48 hours.

When production is resumed, the first oil produced includes large amounts of observable asphaltene chunks and scale. After two hours of production, the oil is free of observable asphaltenes and scale. Production was improved by 80% and maintained by similar treatments performed at 90-day intervals.

### Example 6

### Oil Well Stimulation

A composition is prepared by admixing 94 volume percent Tire Pyrolysis Oil, 3 volume percent Terpenes, and 3 volume percent Nano Surfactant.

An oil well is treated with the composition where the oil well has the following characteristics: 1) produces an extremely low gravity oil (11 API), 2) has very little bottom hole pressure, and 3) site has no artificial lift and no power. For at least the last five years of production, the wells required 30-day production shut down in order to accumulate bottom hole pressure sufficient for two days production averaging about 100 barrels a month.

250 gallons of the composition is introduced downhole through the annulus of the well and the displaced out through the casing using nitrogen. The well is then shut in for five days. Upon resumption of production, the well produced for 60 days producing 1800 barrels a day heavy oil before bottom hole pressure equalized with static pressure from well tubing. The well retreated in substantially the same manner with substantially the same result.

### Example 7

### Corrosion Inhibitor

A composition is prepared by admixing 97.5 volume percent Tire Pyrolysis Oil and 2.5 volume percent Nano Surfactant.

An oil well producing large amounts of water oil well and have high levels of failures due to corrosion is treated with the composition. The well required that joints of tubing be replaced every 3 to 6 months.

The entire tubing volume was displaced with the composition and the well is shut in for 24 hours.

Production is resumed. No tubing failure occurs during the subsequent 12 months.

### Example 8

### Crude Oil Density Reduction

Crude Oil is combined with Tire Pyrolysis Oil and condensate at varying combinations in an experiment to reduce both density and the volume of condensate required. The results are set forth in FIG. 4.

### Example 9

### Crude Oil Viscosity Reduction

### First Test

A first comparative admixture is prepared by blending a sample of crude oil with 20 volume percent of naphtha to a pumpable viscosity.

A second admixture of the application is prepared by mixing the same crude oil with only 8.8 volume percent naphtha and 1.2 volume percent of Tire Pyrolysis Oil to achieve about the same pumpable viscosity. The introduction of only 1.2 volume percent of Tire Pyrolysis Oil into the naphtha and crude oil mixture enabled the naphtha concentration to be reduced from 20 volume percent to 8.8 volume percent at the target viscosity.

### Second Test

The second test is conducted to compare the viscosity of a control sample consisting of crude and naphtha with the viscosity of an admixture consisting of crude, naphtha, and a small amount of Tire Pyrolysis Oil.

A mixture of 90 volume percent crude oil and 10 volume percent naphtha was prepared. The viscosity was measured at 60° C.

Additional admixtures were prepared and tested as shown in the table. Admixtures containing small concentrations of Tire Pyrolysis Oil in naphtha demonstrated lower viscosity than mixtures without Tire Pyrolysis Oil.

The control mixture was a composition of 90 vol % crude and 10 vol % naphtha. Based on the results shown in the Table, the viscosity of the admixture consisting of 90 vol % crude/8 vol % naphtha/2 vol % TPO had an average viscosity 40% lower than the control. The viscosity of the admixture consisting of 91.5 vol % crude/8 vol % naphtha/0.5 vol % TPO had an average viscosity 46% lower than the control. This surprising result demonstrated a substantial improvement in viscosity occurred when a small amount of TPO was substituted for diluent in a mixture with heavy crude.

TABLE
Viscosity at 60° C.

| | | | Average |
|---|---|---|---|
| | Viscosity 1 | Viscosity 2 | Viscosity |
| Product | (cSt) | (cSt) | (cSt) |
| Crude and naphtha (5 vol %) | 491.1 | 410.3 | 450.68 |
| Crude and naphtha (10 vol %) | 277.2 | 223.1 | 250.2 |
| Crude and TPO (5 vol %) | 402.7 | 371.6 | 387.2 |
| Crude and TPO (10 vol %) | 105.7 | 122.1 | 113.9 |
| Mixture 90-8-2 (vol %) ¹ | 139.3 | 163.6 | 151.5 |
| Mixture 90-6-4 (vol %) ² | 133.1 | 130.4 | 131.8 |
| Mixture 91.5-8-0.5 (vol %) ³ | 137.0 | 135.8 | 136.4 |

Footnotes:
¹ Mixture 90 vol % crude/8 vol % naphtha/2 vol % TPO
² Mixture 90 vol % crude/6 vol % naphtha/4 vol % TPO
³ Mixture 91.5 vol % crude/8 vol % naphtha/0.5 vol % TPO

### Example 10

### Bitumen/Heavy Crude Oil Viscosity Reduction

Test Method: 1. Introduce decanted emulsion of free sample into a test vessel. 2. Add 7.5 ppm per gallon of reverse emulsion breaker to the sample. 3. Isolate the sample overnight to allow for any reverse emulsion and water to break out of free oil. 4. Pour free oil into numbered 100 mL prescription bottles. 5. Add diluent to a first prescription bottle as a control. 6. Add diluent and Tire Pyrolysis Oil in predetermined ratios, recording the ratio and the prescription bottle number. 7. Allow the samples and control to sit overnight to allow for water to settle in prescription bottles. 8. Employing a thieve, retrieve a sample from the top of the prescription bottle and test for kinematic and dynamic viscosity with density.

A sample of Heavy Crude Oil is tested employing condensate as a diluent. The results of this test are reported in FIG. 1. The concentration of the Tire Pyrolysis Oil is shown on the X axis of the graph. Normalized viscosity is shown on the Y axis. The control mixture was 86 volume percent heavy crude and 14 volume percent condensate. During the test, Tire Pyrolysis Oil was substituted incrementally for condensate. The first sample was 0.5 volume percent Tire Pyrolysis Oil which showed a reduction of about 60% of the viscosity of the control mixture. The second sample was 1.0 volume percent Tire Pyrolysis Oil which showed a reduction of about 70% of the viscosity of the control mixture. The maximum reduction in viscosity was observed to be about 80% at an interpolated tire Pyrolysis Oil concentration of about 1.3 volume percent. Surprisingly, increasing the amount of Tire Pyrolysis Oil was less effective as is shown at the graph where the viscosity starts to increase with the addition of more Tire Pyrolysis Oil.

As shown in FIG. 1, the employment of a small amount of Tire Pyrolysis Oil in a solvent such as condensate greatly improves the efficiency of the condensate at reducing Heavy Crude Oil. It follows then that the Tire Pyrolysis Oil may be introduced into a diluent to reduce the amount of diluent needed to achieve the same viscosity as unmodified diluent.

As shown in FIG. 2, Tire Pyrolysis Oil, when used at 1 volume percent concentration, is able to reduce the volume of condensate diluent required to achieve a target viscosity in a heavy crude oil by a volume factor of 20.

As shown in FIG. 3, Tire Pyrolysis Oil, when used at 0.5 volume percent concentration, is able to reduce the volume of condensate diluent required to achieve a target density in a heavy crude oil by a volume factor of 8.

As shown in FIG. 4, use of Tire Pyrolysis Oil reduced the density of crude oil while requiring less condensate to do so.

What is claimed is:

1. A composition comprising Pyrolysis Oil wherein the composition is selected from the group consisting of: pipeline cleaner, tank cleaner, paraffin inhibitor or modifier, asphaltene inhibitor or modifier, scale inhibitor, corrosion inhibitor, stimulation fluid, crude oil density reducer, and crude oil viscosity reducer.

2. The composition of claim 1 wherein the composition is a pipeline cleaner.

3. The composition of claim 1 wherein the composition is a tank cleaner.

4. The composition of claim 1 wherein the composition is a paraffin inhibitor or modifier.

5. The composition of claim 1 wherein the composition is an asphaltene inhibitor or modifier.

6. The composition of claim 1 wherein the composition is a scale inhibitor.

7. The composition of claim 1 wherein the composition is a corrosion inhibitor.

8. The composition of claim 1 wherein the composition is a stimulation fluid.

9. The composition of claim 1 wherein the composition is a crude oil density reducer.

10. The composition of claim 1 wherein the composition is a crude oil viscosity reducer.

11. The composition of claim 1 where in the Pyrolysis Oil is prepared using the method of U.S. Pat. No. 6,835,861.

12. The composition of claim 1 where in the Pyrolysis Oil is prepared using the method of U.S. Patent Publication No. 2008/0096787.

13. A crude oil additive comprising naphtha and Pyrolysis Oil.

14. A crude oil additive comprising condensate and Pyrolysis Oil.

15. A method for reducing the viscosity of crude oil comprising introducing a viscosity reducing agent into the crude oil wherein the viscosity reducing agent comprises a diluent and Pyrolysis Oil.

16. The method of claim 15 wherein the Pyrolysis Oil is present in the viscosity reducing agent at a concentration of from about 0.1 to about 99 volume percent.

17. The method of claim 15 wherein the diluent is naphtha.

18. The method of claim 15 wherein the diluent is condensate.

19. The composition of claim 1 wherein the Pyrolysis Oil is Tire Pyrolysis Oil.

20. The crude oil additive of claim 13 wherein the Pyrolysis Oil is Tire Pyrolysis Oil.

21. The crude oil additive of claim 14 wherein the Pyrolysis Oil is Tire Pyrolysis Oil.

22. The method of claim 15 wherein the Pyrolysis Oil is Tire Pyrolysis Oil.

23. The crude oil additive of claim 13 wherein the crude oil additive is a heavy crude oil additive.

24. The crude oil additive of claim 14 wherein the crude oil additive is a heavy crude oil additive.

25. The method additive of claim 15 wherein the method is for reducing the viscosity of heavy crude oil.

26. The composition of claim 19 further comprising a member selected from the group consisting of diesel oil, terpenes, limonene, acidifying compounds, nano surfactants, carbon disulfide, 2-butoxy ethanol, ethylene glycol monopropyl ether, ethylene glycol, methanol, ethanol, xylenes, and combinations thereof.

27. The crude oil additive of claim 20 further comprising a member selected from the group consisting of diesel oil, terpenes, limonene, acidifying compounds, nano surfactants, carbon disulfide, 2-butoxy ethanol, ethylene glycol monopropyl ether, ethylene glycol, methanol, ethanol, xylenes, and combinations thereof.

28. The crude oil additive of claim 21 further comprising a member selected from the group consisting of diesel oil, terpenes, limonene, acidifying compounds, nano surfactants, carbon disulfide, 2-butoxy ethanol, ethylene glycol monopropyl ether, ethylene glycol, methanol, ethanol, xylenes, and combinations thereof.

29. The method of claim 22 wherein the viscosity reducing agent further comprising a member selected from the group consisting of diesel oil, terpenes, limonene, acidifying compounds, nano surfactants, carbon disulfide, 2-butoxy ethanol, ethylene glycol monopropyl ether, ethylene glycol, methanol, ethanol, xylenes, and combinations thereof.
